(19) United States
(12) Patent Application Publication
(10) Pub. No.: US 2023/0157343 A1
(43) Pub. Date: May 25, 2023

(54) SYSTEM AND METHOD FOR CREATING PANELA AND CREATING LIQUID SWEETENER OR MELAO FROM PANELA

(71) Applicant: Sweet Melao, LLC, Bayonne, NJ (US)

(72) Inventors: Angela Hill-Quinonez, Bayonne, NJ (US); Maria Williams, Little Elm, TX (US)

(73) Assignee: Sweet Melao, LLC, Bayonne, NJ (US)

(21) Appl. No.: 17/989,726

(22) Filed: Nov. 18, 2022

Related U.S. Application Data
(60) Provisional application No. 63/282,199, filed on Nov. 23, 2021.

(51) Int. Cl. A23L 33/125; A23L 2/60; A23L 33/105

(52) U.S. Cl. CPC A23L 33/125; A23L 2/60; A23L 33/105

(57) ABSTRACT

A method to create a liquid sweetener or melao from panela is described. The method includes adding water and panela to a pot, cooking the panela to form a liquid sweetener, cooling the liquid sweetener, refrigerating the liquid sweetener, utilizing a hydrometer or a similar device to measure a density of the liquid sweetener, and packaging the liquid sweetener. The method may optionally include a process step to modify one or more factors to adjust a quality of the melao and/or a process step to add one or more favoring components to the liquid sweetener to create a specialty beverage. The liquid sweetener or melao may be used to create a food product, such as granola, masas, guapanela, morena, jalea, and/or cocos.

### CROSS-REFERENCE TO RELATED APPLICATIONS SECTION

This application claims priority to U.S. Provisional Patent Application No. 63/282,199 filed on Nov. 23, 2021, which is incorporated by reference for all purposes as if fully set forth herein.

### FIELD OF THE EMBODIMENTS

The field of the invention and its embodiments relate to a system and a method for creating panela. Further, the field of the invention and its embodiments relate to a system and a method for creating a liquid sweetener or melao from the panela.

### BACKGROUND OF THE EMBODIMENTS

Sugar cane is a tall growing monocotyledonous crop that is cultivated in the tropical and subtropical regions of the world primarily for its ability to store high concentrations of sucrose, or sugar, in the internodes of the stem. Typically, the sugar cane grows for about 10 to 18 months before harvest and mature sugar cane stands between two to four meters high and is ideally harvested when the sugar content is at its highest. In Australia and other technically advanced countries, sugar cane is harvested by a variety of mechanical harvesters. The harvesters cut the cane stalks at their base, close to the ground, and feed the cane stalks through a variety of cutting implements to produce billets of cane, which can then be readily collected and transported to the mills for further processing.

The billets of cane are typically collected in bins and are hauled to sugar cane mills by a variety of methods. The cane is then shredded in a hammermill to create a fibrous material. The shredded cane may be fed through a series of crushing mills to extract the sugar rich juice from the fibrous material. Typically, the juice is then dehydrated by boiling, leaving a dry crystalline sugar product.

Though numerous methods are known to produce sugar cane juice and crystalline sugar products, advanced methods are needed to create panela and to create a liquid sweetener or melao from the panela in an unprocessed and natural way. The present invention meets and exceeds these objectives.

### EXAMPLES OF RELATED ART INCLUDE

U.S. Ser. No. 10/632,167B2 describes a method for extracting and processing sugar cane juice from sugar cane stalks to produce a shelf-stable natural juice product preserving policosanols naturally-occurring in raw sugarcane sticks.

WO2020075102A1 describes an automated and continuous system for the grinding and homogenization of dehydrated sugar cane juice (panela). The system includes grinding, homogenization and drying equipment. The system is based on the interaction of grinding equipment that performs uniform and continuous stirring of the product, and which is connected to a homogenizer via a pneumatic channel and drying equipment that uses infrared radiation. The system also includes electronic instrumentation systems and automated control systems to achieve a continuous process.

U.S. Pat. No. 4,523,959A describes a process for purifying sugarcane juices by contacting the juices to be purified in succession with a hydrophobic adsorbent, a supported strong anion exchange material or a hydrophobic adsorbent having anion exchanger groups, an anion exchange resin, and a cation exchange resin. The process may be used to purify low-grade sugar solutions.

U.S. Pat. No. 4,332,622A describes a method to purify sugar cane juice to produce a finished product of high quality.

U.S. Pat. No. 4,627,880A describes a method to produce an unprocessed complete cane sugar with approximately the color and flavor of fresh sugarcane juice and still containing valuable amino acids and vitamins.

U.S. Pat. No. 5,320,035A describes an improved sugar cane juice extractor. CN2195430Y describes a juicer for sugar cane. CN2222720Y describes a sugar cane juice press.

U.S. Pat. No. 6,068,869A describes a method to provide a stabilized sugar cane juice product for use in soft drinks, that includes providing cleaned sugar cane sticks and extracting cane juice from the sticks. Thereafter, the extracted cane juice is acidified immediately upon extraction by feeding it into a solution comprising ascorbic acid for preventing discoloration of the cane juice and also by feeding it simultaneously into an acidic solution of one of citric acid, malic acid, tartaric acid, phosphoric acid and a mixture thereof, for lowering the pH of the cane juice below a pH of 5. Furthermore, one of a sodium citrate solution, a potassium citrate solution, a sodium phosphate di-basic solution or a mixture thereof, is added to the cane juice for stabilizing it. The cane juice is then coagulated and flocculated to remove unwanted foulants and aromas.

U.S. Pat. No. 6,245,153B1 describes a method for extracting and processing sugar cane juice from sugar cane sticks to produce a natural juice product. The method includes: providing sugar cane sticks having a high sucrose level; extracting sugar cane juice from the sugar cane sticks using a roller mill apparatus; filtering the extracted sugar cane juice through a screen filter; stabilizing the pH of the juice in a non-acidic solution of calcium hydroxide; flocculating the sugar cane juice with a mixture of water and at least one natural flocculate product; evaporating the sugar cane juice to form a sugar cane juice concentrate; and extracting the sugar cane juice concentrate from the evaporator.

Juliana Maria Garcia, et al., “Physicochemical and Sensory (Aroma and Colour) Characterisation of a Non-Centrifugal Cane Sugar (“Panela”) Beverage,” Food Chemistry, 2017, 228, Pages 7-13 assesses physicochemical properties and sensory characteristics of panela beverages.

Luis F. Gutierrez-Mosquera, et al., “Advances in Traditional Production of Panela in Colombia: Analysis of Technological Improvements and Alternatives,” Ingenieria y Competitividad, 2018, 20(1), Pages 107-123 describes the traditional system for panela production, from a technical and engineering perspective, and also highlighting some aspects of quality and innovation.

Some similar methods and systems exist in the art. However, their means of operation are substantially different from the present disclosure, as the other inventions fail to solve all the problems taught by the present disclosure.

### SUMMARY OF THE EMBODIMENTS

The present invention and its embodiments relate to a system and a method for creating panela. Further, the present invention and its embodiments relate to a system and a method for creating a liquid sweetener or melao from the panela.

An embodiment of the present invention describes a method to create panela, which includes numerous process steps, such as: harvesting sugar cane from a field, transporting the sugar cane to a factory, and at the factory, crushing the sugar cane in a mill and collecting, boiling, and pouring sugar cane juice into molds, where the sugar cane juice hardens into blocks, or the panela.

Another embodiment of the present invention describes a method to create a liquid sweetener or melao from panela. The method to create the liquid sweetener or melao from panela includes numerous process steps, such as: adding about 0.35 L (liters) of water and about 0.40 L of panela to a pot and cooking the panela to form a liquid sweetener at about 180° C. for about 10 minutes. In some examples, the liquid sweetener reaches about 150° C. to obtain a desired consistency.

Next, the method includes: cooling the liquid sweetener to room temperature for about 30 minutes. Then, the method includes refrigerating the liquid sweetener for about five hours. In some examples, the method also includes utilizing a device to measure a density of the liquid sweetener, where the density of the liquid sweetener is preferably about 1.44 g/mL. Next, the method includes packaging the liquid sweetener. It should be appreciated that the liquid sweetener created by this method is a natural sweetener.

In some examples, the method may further include modifying one or more factors (e.g., a quality of the panela, the cooking time, the water quality and/or the pot size, among others) to adjust a quality of the melao or the liquid sweetener. In other examples, the method may further include adding one or more favoring components to the liquid sweetener to create a specialty beverage.

The flavoring component may include: a vanilla flavoring component, a caramel flavoring component, a hazelnut flavoring component, a citrus flavoring component, a cinnamon flavoring component, a cappuccino flavoring component, an amaretto flavoring component, a mocha flavoring component, a cocoa flavoring component, a cardamom flavoring component, a maple syrup flavoring component, a honey flavoring component, a pumpkin flavoring component, a ginger flavoring component, a blueberry flavoring component, a chai flavoring component, a chamomile flavoring component, a cranberry flavoring component, an echinacea flavoring component, an apple flavoring component, an elderberry flavoring component, a hibiscus flavoring component, a coffee flavoring component, a chocolate flavoring component, a eucalyptus flavoring component, a lemon flavoring component, a lemongrass flavoring component, a mango flavoring component, a mint flavoring component, an orange flavoring component, a peach flavoring component, an almond flavoring component, a pomegranate flavoring component, a berry flavoring component, a raspberry flavoring component, a strawberry flavoring component, and/or a turmeric flavoring component, among others.

In other examples, the method further includes: utilizing the liquid sweetener to create a food product, where the food product includes granola, guapanela, masas, morena, jalea, and/or cocos, among others.

### BRIEF DESCRIPTION OF THE DRAWINGS

FIG. 1 depicts a block diagram of a method to create a liquid sweetener, or melao, from panela, according to at least some embodiments disclosed herein.

FIG. 2 depicts a block diagram of a method to create the panela of FIG. 1, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

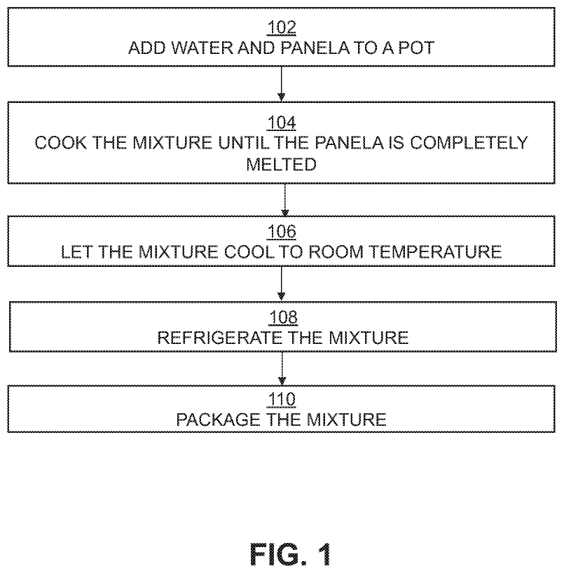

A method to create a liquid sweetener, or melao, from panela is depicted in FIG. 1. The method of FIG. 1 may utilize equipment, such as an aluminum pot, a thermometer/hydrometer, a digital refractometer to measure a density, a sterilized bottle or package, and/or a metal spoon, among other pieces of equipment not explicitly listed herein.

The method of FIG. 1 begins with a process step 102 that includes adding water and panela to a pot (e.g., a 32 ounce or 0.95 L capacity (7-8″) aluminum pot). In examples, an amount of the water is about 0.35 L or 12 ounces and an amount of the panela is about 0.41 L or 14 ounces.

It should be appreciated that panela is an unrefined whole cane sugar. More specifically, panela is a solid form of sucrose derived from the boiling and evaporation of sugar cane juice. Panela may be sold in many forms, including a liquid form, a granulated form, and a solid block form. In preferred examples, the panela descried herein comes from Colombia (or other countries) because production methods are more specialized, and producers receive better training to handle the product.

The process step 102 is followed by a process step 104 that includes cooking the mixture of water and panela (of the process step 102) until the panela is completely melted. Evaporation is carried out by boiling the panela until its sugar content reaches a predetermined and preferred concentration. In examples, the boiling occurs at about 180° C. for about 10 minutes. In some examples, a temperature of the liquid sweetener or melao reaches about 300° F. or 149° C. to obtain proper consistency. In other examples, the liquid sweetener or melao is heated up to about 200° F. or 93° C. to make the sugar in the melao more concentrated until it reaches caramelization.

A process step 106 follows the process step 104 and includes cooling the mixture to room temperature. In examples, the process step 106 occurs for about 30 minutes.

A process step 108 follows the process step 106 and includes refrigerating the mixture. In examples, the mixture is refrigerated for about five hours such that the liquid sweetener or melao reaches a density of about 1.44 g/mL. In another embodiment, the mixture may not be refrigerated.

Syrup density is often measured in Brix, where one Brix is equal to about 1% sugar content. For example, the correct density for maple syrup is between 66° and 68° Brix, with some local jurisdictions that have strict maple laws requiring a narrower range. Numerous devices may be used to measure the density of the liquid sweetener or melao, such as a thermometer, a hydrometer, a hydrotherm, a reactometer, an automatic draw-off, or a tool-less measurement means, among others known to those having ordinary skill in the art.

In preferred examples, the hydrometer, or an instrument used for measuring the relative density of liquids based on the concept of buoyancy, may be used to test the density of the liquid sweetener or melao. The most common type of hydrometer is a glass tube with a weighted bulb at the bottom and a paper scale running up the inside of the tube. By setting the hydrometer in a column of syrup, usually a hydrometer cup, an accurate density measurement can be taken based on where the scale of the hydrometer floats at the top of the liquid. For example, to obtain a correct density of the liquid sweetener or melao, a red line of the hydrometer has to be even with the surface of the liquid. If the red line of the hydrometer is above the liquid sweetener or melao, the texture of the liquid sweetener or melao will be too thick and the liquid sweetener or melao will have to be watered down and boiled for another minute to better integrate the water into the mixture.

Next, a process step 110 follows the process step 108 and includes packaging the mixture. In examples, the liquid sweetener or melao is packaged in a 12 ounce (or 0.35 L) or a 16 ounce (or 0.47 L) bottle or similar packaging. In other embodiments, the melao may be packaged in small or large quantities that 12 or 16 ounces. During packaging, about three inches of headspace is left in the bottle to assure a vacuum seal. In some examples, to preserve the liquid sweetener or melao, the bottle is put upside down to allow the bottle to seal properly and preserve the product.

After breaking the seal or opening a sealed bottle, the liquid sweetener or melao is preferably refrigerated to prevent spoilage. A sealed bottle of liquid sweetener or melao may have a shelf life of at least six months. The process step 110 concludes the method of FIG. 1. It should be appreciated that the liquid sweetener or melao formed from the method of FIG. 1 is the result of a natural and unprocessed method, making the melao healthier than other sugar products.

Further, it should be appreciated that a quality of the liquid sweetener or melao depends on numerous factors, such as a quality of the panela, the cooking time, the water quality and the pot size. Moreover, in examples, one or more flavoring components may be added to the liquid sweetener or melao to create specialty beverages. In examples, the flavoring component may be a natural flavoring component or an artificial flavoring component. The flavoring component may be: a vanilla flavoring component, a caramel flavoring component, a hazelnut flavoring component, a citrus flavoring component, a cinnamon flavoring component, a cappuccino flavoring component, an amaretto flavoring component, a mocha flavoring component, a cocoa flavoring component, a cardamom flavoring component, a maple syrup flavoring component, a honey flavoring component, a pumpkin flavoring component, a ginger flavoring component, a blueberry flavoring component, a chai flavoring component, a chamomile flavoring component, a cranberry flavoring component, an echinacea flavoring component, an apple flavoring component, an elderberry flavoring component, a hibiscus flavoring component, a coffee flavoring component, a chocolate flavoring component, a eucalyptus flavoring component, a lemon flavoring component, a lemongrass flavoring component, a mango flavoring component, a mint flavoring component, an orange flavoring component, a peach flavoring component, an almond flavoring component, a pomegranate flavoring component, a berry flavoring component, a raspberry flavoring component, a strawberry flavoring component, and/or a turmeric flavoring component, among others not explicitly listed herein. It should be appreciated that the flavoring component may be in a powder form or an extract form. In an example, to create a beverage to treat common cold, a eucalyptus extract and/or or a lemon extract may be added to the liquid sweetener or melao such that the liquid sweetener or melao can be an instant drink that only needs water to be added and heat prior to consumption by the user.

It should be appreciated that the liquid sweetener, or melao, formed from the method of FIG. 1 may be used to create one or more food products, such as: granola, guapanelas, masas, morenas or cookies, jalea, and/or cocos, among others not explicitly listed herein. Examples of these food products are described herein.

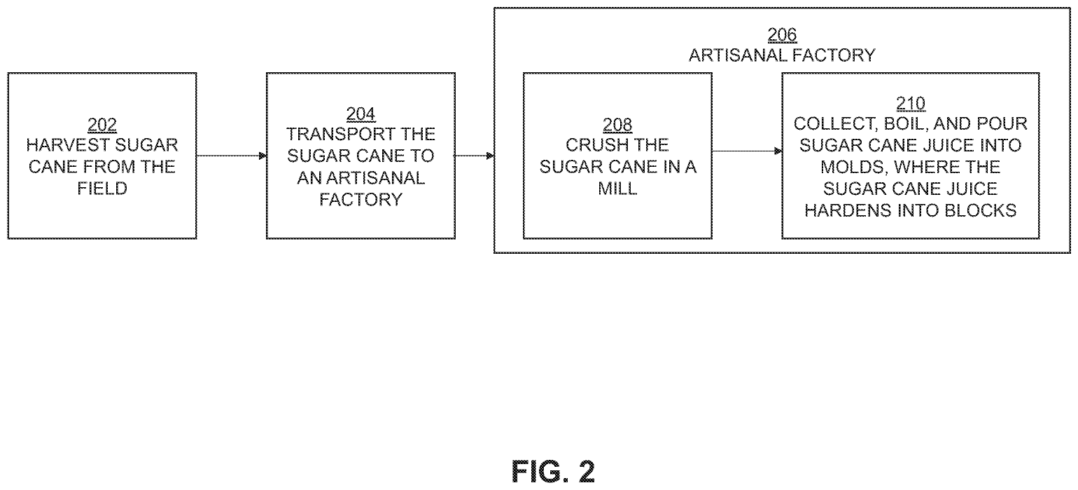

In FIG. 2, the present invention also describes a method to create the panela (which is used in the method of FIG. 1). The method of FIG. 2 begins at a process step 202, where sugar cane is harvested from a field. A process step 204 follows the process step 202 and includes transporting the sugar cane to an artisanal factory 206 or a trapiche. At the artisanal factory 206, a process step 208 follows the process step 204 and includes crushing the sugar cane in a mill. Further, at the artisanal factory 206, a process step 210 follows the process step 208 and includes collecting, boiling, and pouring sugar cane juice into molds, where the sugar cane juice hardens into blocks, or panela. The process step 210 concludes the method of FIG. 2. The hardened blocks or panela are sweeter and healthier than traditional sugar. The color and flavor of the panela depends on production quality and evaporation techniques.

### EXAMPLES

### Example 1—Granola

In Example 1, a method to create granola, using the liquid sweetener, or the melao, from the method of FIG. 1 is described. Equipment used in this example may include: a 10.25×10.25×5.25 inch metallic mixing bowl, a measuring cup, a long handle wooden spoon, a 10 inch silicone spatula, sheets of parchment paper, an alloy steel 0.66×9×13 inches baking sheet, and an oven.

About 0.5 cups (or 0.11 L) of melao and about 1 cup (or 0.24 L) of coconut oil is mixed in a bowl. The mixture of the melao and coconut oil is poured into about 0.5 cups (or 64 grams) of oats. The mixture is stirred to mix the components together. The oats are placed in an oven at about 350° F. (or 177° C.) for about five minutes.

In a separate bowl, about 0.5 cups (or 64 grams) of raisins and about 0.5 cups (or 64 grams) of chopped almonds are mixed and cooked until they are slightly toasted. When the oats are ready, all of the components are mixed together and the granola is allowed to cool down. In a separate pan, the almonds and raisins are toasted in a warm pot for about 2 minutes. It should be appreciated that optional components/ingredients to be used in this example include about 0.5 cups (or 64 grams) of coconut flakes and/or about 0.5 cups (or 64 grams) of dried cranberries, among others.

### Example 2—Guapanelas

In Example 2, a method to create guapanelas, using the liquid sweetener, or the melao, from the method of FIG. 1 is described. In this example, about 12 ounces (or 0.35 L) of seltzer water, about 50 grams of the liquid sweetener or the melao and about 3.5 ounces (or 99 grams) of fruit pulp (e.g., passion fruit, lemon, pineapple, and/or ginger fruit pulp, among others) is mixed together. It should be appreciated that the liquid sweetener or melao acts as a sweetener for the guapanelas.

### Example 3—Morenas

In Example 3, a method to create morenas or cookies, using the liquid sweetener, or the melao, from the method of FIG. 1 is described. About 250 grams of flour, about 1 pinch of baking soda, and about 0.5 tbs (or 7.5 grams) of grounded orange and lemon skin is mixed together. About 60 grams of butter and about 0.5 cups (or 0.11 L) of melao is then mixed together. Then, about 100 grams (or 0.1 L) of water, about 0.5 tbs (or 6.39 grams) of yeast, about 1 pinch of salt, about 0.5 tbs (or 7.5 grams) of spices (e.g., ground cloves and cinnamon), and about one-fourth of baking powder diluted in 0.5 tbs (or 7.4 mL) of milk is mixed with the previous components. The mixture is then baked in the oven at 350° F. (or 177° C.) for over 20 minutes.

### Example 4—Jalea

In Example 4, a method to create jalea having a marmalade or jam consistency using the liquid sweetener, or the melao, from the method of FIG. 1 is described. About 6 ounces (or 0.18 L) of melao is mixed with juice from about 8 ounces (or 226 grams) of fruit pulp until it becomes thick.

Numerous flavors of the juice are contemplated herein, such as mango, pineapple, ginger, lemon, and/or coffee, among others. For the mango and pineapple flavors, about 8 ounces (or 0.24 L) of water is added to about 0.5 cups (or 64 grams) of mango or pineapple juice. Chopped mango or pineapple may also be added to the final jalea product. In an alternative embodiment chopped fruit does not have to be added. For the ginger flavor, about 1 tbs (or 12.78 grams) of ginger powder may be added to water. Small pieces of ginger root may also be added to the final jalea product. For the coffee and lemon flavors, about 8 oz (or 0.24 L) of coffee/lemon extract may be added.

Then, about 1 tbs (or 12.78 grams) of organic pectin and 1 tbs (or 12.78 grams) of citric acid is dissolved with a little juice, and is then poured in the mixture and stirred until it becomes very thick. Thickening agents such as corn starch may also be used. This method may also involve the addition of preservatives.

### Example 5—Cocos

In Example 5, a method to create cocos using the liquid sweetener, or the melao, from the method of FIG. 1 is described. The cocos may be hard or soft candy having a caramel consistency.

About 7 ounces (or 0.21 L) of panela is mixed with about 0.5 cups (or 0.11 L) of water. About 0.5 tbs (or 12.78 grams) of ground cloves and cinnamon is then added. The mixture is mixed until it turns into a thick syrup. The cloves may then be removed from the mixture and about 1 cup (or 128 grams) of shredded coconut may be added to the mixture. In some examples, about 1 cup (or 128 grams) of shredded pineapple is added. The mixture is then placed into molds until it is cold and dried. The flavor of the cocos may be modified to others, such as passion fruit, pineapple, dulce de leche, coffee, lemon, etc. by adding these flavoring components.

### Example 6—Masas

In Example 6, a method to create masas using the liquid sweetener, or the melao, from the method of FIG. 1 is described. Masas is a sweet and salty, flat pastry cut in small pieces, similar to nachos that may be consumed with the jalea of Example 4. Equipment needed to create the masas of this example includes an industrial flat machine, an oven, and a square mold to make the masas.

Numerous components are mixed, including about 1 cup (or 128 grams) of flour, about 0.5 cups (or 0.11 L) of melao, about 0.5 cups (or 64 grams) of butter, about 1 tbs (or 12.78 grams) of baking powder, and about 1 pinch of sea salt. Once these components are mixed, they form a dough. The dough is then flattened using an industrial flat machine. Next, the dough is cut into chips of a square shape. However, other shapes are contemplated by Applicant. The chips or masas are baked in an oven for about 20 minutes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method to create a liquid sweetener or melao, the method comprising:
adding water and panela to a pot;
cooking the panela to form a liquid sweetener;
cooling the liquid sweetener;
packaging the liquid sweetener;
and optionally refrigerating the liquid sweetener; and

2. The method of claim 1,
wherein an amount of the water is about 0.35 L, and
wherein an amount of the panela is about 0.40 L.

3. The method of claim 1, wherein the cooking of the panela to form the liquid sweetener occurs at about 180° C. for about 10 minutes.

4. The method of claim 3, wherein the liquid sweetener reaches about 150° C. to obtain a desired consistency.

5. The method of claim 1, wherein the liquid sweetener is cooled to room temperature for about 30 minutes.

6. The method of claim 1, wherein the refrigerating the liquid sweetener occurs for about five hours.

7. The method of claim 6, further comprising:
utilizing a device to measure a density of the liquid sweetener.

8. The method of claim 7, wherein the device is selected from the group consisting of: a thermometer, a hydrometer, a hydrotherm, a reactometer, an automatic draw-off, and a tool-less measurement means.

9. The method of claim 7, wherein the density of the liquid sweetener is about 1.44 g/mL.

10. The method of claim 1, wherein the liquid sweetener is natural.

11. The method of claim 1, further comprising:
modifying one or more factors to adjust a quality of the liquid sweetener.

12. The method of claim 11, wherein each factor of the one or more factors is selected from the group consisting of: a quality of the panela, a cooking time, a water quality and a size of the pot.

13. The method of claim 1, further comprising:
adding one or more favoring components to the liquid sweetener to create a beverage.

14. The method of claim 13, wherein each flavoring component of the one or more favoring components is selected from the group consisting of: a vanilla flavoring component, a caramel flavoring component, a hazelnut flavoring component, a citrus flavoring component, a cinnamon flavoring component, a cappuccino flavoring component, an amaretto flavoring component, a mocha flavoring component, a cocoa flavoring component, a cardamom flavoring component, a maple syrup flavoring component, a honey flavoring component, a pumpkin flavoring component, a ginger flavoring component, a blueberry flavoring component, a chai flavoring component, a chamomile flavoring component, a cranberry flavoring component, an echinacea flavoring component, an apple flavoring component, an elderberry flavoring component, a hibiscus flavoring component, a coffee flavoring component, a chocolate flavoring component, a eucalyptus flavoring component, a lemon flavoring component, a lemongrass flavoring component, a mango flavoring component, a mint flavoring component, an orange flavoring component, a peach flavoring component, an almond flavoring component, a pomegranate flavoring component, a berry flavoring component, a raspberry flavoring component, a strawberry flavoring component, and a turmeric flavoring component.

15. The method of claim 1, further comprising:
utilizing the liquid sweetener to create a food product.

16. The method of claim 15, wherein the food product is selected from the group consisting of: granola, guapanela, morena, jalea, masas and cocos.

17. The method of claim 1, wherein the panela is created by:
harvesting sugar cane from a field;
transporting the sugar cane to a factory; and
at the factory,
crushing the sugar cane in a mill; and
collecting, boiling, and pouring sugar cane juice into molds, where the sugar cane juice hardens into blocks resulting in panela.
